(19) United States
(12) Patent Application Publication
(10) Pub. No.: US 2007/0006481 A1
(43) Pub. Date: Jan. 11, 2007

(54) Increased negative static pressure fluid bed drying

(76) Inventor: Gary Albert Eck, Fairfield, NJ (US)

Correspondence Address: Gary A. Eck, 61 Deer Park Road, Fairfield, NJ, 07004, US

(21) Appl. No.: 11/174,340

(22) Filed: Jul. 5, 2005

(51) Int. Cl. F26B 19/00; F26B 3/08

(52) U.S. Cl. 34/360; 34/60

(57) ABSTRACT

The present invention is for a process for providing fluid bed drying of material in an intentionally higher negative pressure atmosphere in the area of the material being dried. This intentional negative pressure of an additional approximate minus 1 to minus 10 inches of water column or more of static pressure is greater than that which is encountered and inherent with standard engineering design of fluid bed drying equipment, accessories and auxiliary equipment or what is commonly referred to as atmospheric fluid bed drying. This will significantly decrease the drying times of most if not all solvent based granulations.

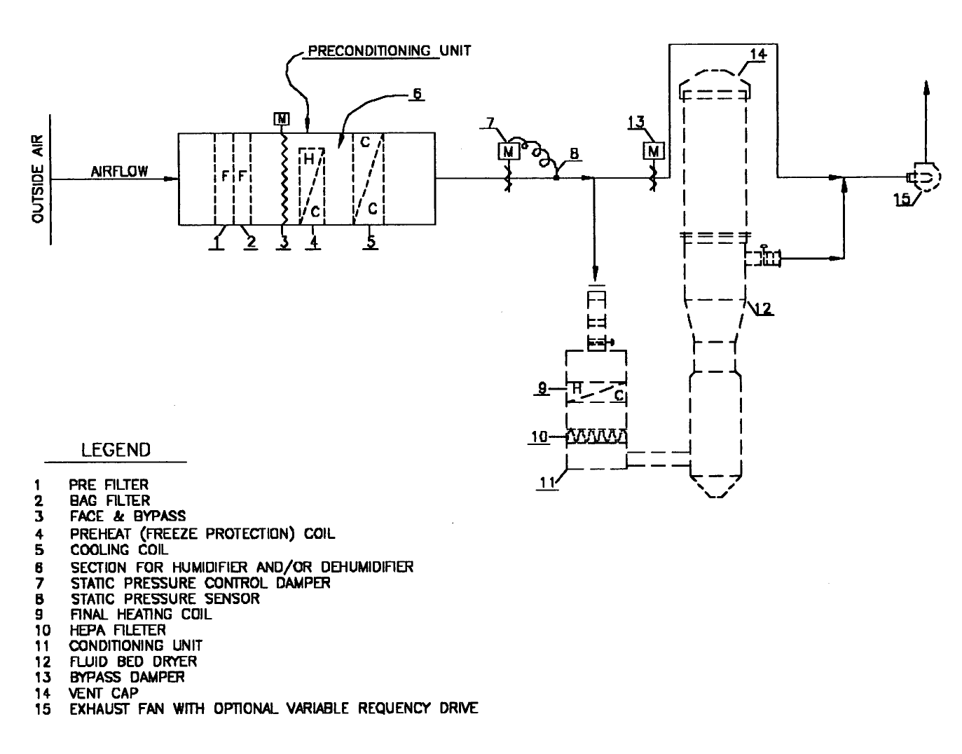

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC/REFERENCE TO A “MICROFICHE APPENDIX”

Not Applicable

### BACKGROUND OF THE INVENTION

(1) Field of Invention
Technology Center—Mechanical
Utility Application
Proposed U.S. Classification—34/181

(2) Background Art
Fluid Bed drying

One method commonly utilized for drying wetted materials such as granulations especially in pharmaceutical processing is a process referred to as fluid bed drying.

In fluid bed drying uniform processing conditions are achieved by inducing or pulling by an exhaust fan a gas, usually air, through a product layer, commonly referred to as a granulation which is usually solvent based, under controlled velocity conditions thereby creating a fluidized state of the material. The air for fluidizing and drying is typically drawn from outside the building, through pre-filters, possibly a preheating and/or freeze protection coil, dehumidifier, humidifier, final heater, temperature control device and HEPA final filters. Exiting the product bed the moisture laden air passes through some type of product/air filter, the main exhausting fan, possibly a final filter and exhausted to the atmosphere. If the processing involves organic solvents, abatement systems may also be incorporated. Heat is supplied to the fluidizing air by the heating coil. Heat to the gas flow however could also be supplied by heating/heater surfaces within the fluid bed area.

Some negative static pressure is inherent within the fluid bed being the air stream is induced or pulled through the system and due to the resistance to airflow by equipment in the air stream such as but not limited to filters, heating coils, cooling coils, ductwork, louvers, air handing equipment and accessories, fans, dehumidification equipment, and humidification equipment. Good engineering practice however minimizes the negative static pressure caused by this equipment.

Fluid bed drying has advantages over other methods of drying wetted particulate materials. Particle fluidization results in high rates of heat exchange at high thermal efficiency while reducing the possibility of overheating of individual particles.

The properties of a given product are determined from drying data such as how volatile content changes with time in a batch fluid bed operating under controlled conditions. Other important properties include but are not limited to equilibrium volatile content, boiling point and flash point.

Fluid bed drying is suited for powders, granules, agglomerates and pellets.

Fluid bed drying is rapid due to the entire product surface being exposed to a high volume air stream.

Some variations of the types of fluid bed drying are batch, continuous flow, vibratory and double/dual deck.

A related but significantly different process is vacuum fluid bed drying which is a process whereby the negative static pressure in the area of drying can be minus 150 to minus 200 mbar (−335″ to −356″ of water column). Vacuum fluid bed drying is usually a totally enclosed system and the equipment arrangement is significantly different.

### BRIEF SUMMARY OF THE INVENTION

The present invention provides for a process with intentionally greater negative static pressure fluid bed drying ranging from approximately minus 1 to minus 10 inches or more of water column over and above the normal inherent negative static pressure in the area of the material being dried.

This additional negative static pressure will lower the boiling point of the solvent utilized and/or tend to draw the solvent out of the material being dried. This will significantly decrease the drying times of the materials being dried and will be effective with most if not all solvents utilized in/with various granulations. The amount of decreased drying time will vary dependent on a multitude of other variables inherent with the fluid bed drying process.

Due to the numerous combinations of a multitude of granulations and solvents the possibility of case hardening due to faster drying must be considered.

Additionally it must be recognized that increasing the negative static pressure in the fluid bed dryer will require increased horsepower for the exhaust fan. All components must be properly engineered to handle this increased negative static pressure.

### BRIEF DESCRIPTION OF THE VIEW OF THE DRAWING

### (Reference Drawing Titled “Increased Negative Static Pressure Fluid Bed Dryer Arrangement” Dated Apr. 16, 2005)

This drawing shows only one example of an equipment arrangement in accordance with the present invention to provide intentional higher negative static pressure within the dryer. It is simplistic in nature and in no way is inclusive of all required control, system and accessory equipment.

### DETAILED DESCRIPTION OF THE INVENTION

### (Reference Drawing Titled “Increased Negative Static Pressure Fluid Bed Dryer Arrangement” Dated Apr. 16, 2005)

Preconditioning Unit

Accessory equipment such as but not limited to pre-filters, bag filters, face-and-bypass dampers, humidifiers, dehumidifiers, cooling coils and heating coils (components #1 through #6) are typically installed in the Preconditioning Unit. The arrangement of all the accessory equipment must be properly designed to precondition the incoming air which usually is drawn from the outside to meet the desired Preconditioning Unit discharge conditions. It is highly desirable however that if a cooling coil is utilized for dehumidification that it is located in the Preconditioning Unit and/or outside the intentionally increased negative static pressure region thereby resulting in more effective and efficient moisture removal from the incoming air stream.

Static Pressure Control Damper (Component #7)

The Static Pressure Control Damper and its associated Static Pressure Sensor (component #8) and an appropriate controller are key components which will allow the automatic control of additional negative static pressure to be imparted in the desired area of drying in the Fluid Bed Dryer (component #12). By incrementally partially closing the Static Pressure Control Damper the negative static pressure can be increased. A manual arrangement can also be utilized. The static Pressure Control Damper can be located anyplace upstream of the fluid bed dryer. Locating the Damper as close to the dryer as possible however will reduce the amount of system components which must be designed for the intentionally greater negative static pressure.

Exhaust Fan (Component #15)

The exhaust fan draws, pulls or induces the fluidizing gas through the system. The exhaust fan is designed to overcome all air flow resistances in the system and to draw through the proper quantity of fluidizing gas. Intentionally increasing the negative static pressure in the system with the noted arrangement will require the exhaust fan to be analyzed for proper sizing, classification and horsepower requirements. Additionally due to varying conditions and/or products being dried it is desirable to have the exhaust fan motor rated for inverter duty and controlled with a variable frequency drive (controller).

The foregoing is considered as illustrative only of the principal of the invention to provide an intentional increase in negative static pressure in the fluid bed dryer thereby decreasing drying times. It is also recognized that various other equipment arrangements can be conceived for intentionally increasing the negative static pressure in the area of drying. One such method to intentionally increase the negative static pressure could involve but is not limited to designing air stream components upstream of the dryer smaller or with higher resistance to the air flow. Since numerous modifications, changes and arrangements will readily occur to those skilled in the art, it is not desired to limit the invention to the exact arrangement, construction or operation as shown and described and accordingly all suitable modifications and equivalents may be resorted to, falling within the scope of the invention as claimed.

1. The invention claimed is a process whereby a higher negative static pressure ranging from approximately minus 1 to minus 10 inches or more of water column is imparted in the drying area of the fluid bed dryer thereby decreasing drying times. The amount of decreased drying time will vary dependent on a multitude of other variables inherent with the fluid bed drying process.
